(19) United States
(12) Patent Application Publication
(10) Pub. No.: US 2013/0075561 A1
(43) Pub. Date: Mar. 28, 2013

(54) SLIDE ASSEMBLY WITH TILT MOUNT

(71) Applicant: Jonathan Manufacturing Corporation dba Jonathan, Irvine, CA (US)

(72) Inventor: Gaetano G. Galletti, Costa Mesa, CA (US)

(73) Assignee: JONATHAN MANUFACTURING CORPORATION dba JONATHAN ENGINEERED SOLUTIONS, Irvine, CA (US)

(21) Appl. No.: 13/621,400

(22) Filed: Sep. 17, 2012

Related U.S. Application Data
(60) Provisional application No. 61/536,405, filed on Sep. 19, 2011.

(51) Int. Cl. F16M 13/02

(52) U.S. Cl. 248/276.1

(57) ABSTRACT

A slide assembly with tilt mount includes an outer slide segment defining a first length and an inner slide segment slidably engaged with the outer slide segment. The inner slide segment defines a second length that is less than said first length. A mount is carried by the inner slide segment and includes a mounting bracket configured to support a piece of electronic equipment, such as a monitor. At least one pivot assembly is interposed between the mount and the inner slide segment. The at least one pivot assembly permits the mount to be tilted relative to the inner slide segment. Preferably, the slide assembly permits at least four locked positions of the monitor or other electronic equipment.

### CROSS-REFERENCE TO RELATED APPLICATIONS

This application is related to and claims the benefit of U.S. Provisional Patent Application No. 61/536,405, filed Sep. 19, 2011, the entirety of which is hereby incorporated by reference herein.

### BACKGROUND OF THE INVENTION

1. Field of the Invention

The present invention relates to slide assemblies and tilt mounts. In particular, the present invention relates to a slide assembly with a tilt mount for electronic equipment, such as a monitor, that is mountable in a vehicle.

2. Description of the Related Art

It is sometimes desirable to mount electronic equipment, such as a monitor, in a vehicle. Often, the electronic equipment is mounted in a fixed position. In some applications, the electronic equipment is mounted such that limited movement is permitted. For example, rotational or tilt movement of the electronic equipment may be permitted.

### SUMMARY OF THE INVENTION

However, a need exists for improved mounting arrangements for electronic equipment that permit tilting movement and translation or sliding movement of the electronic equipment. The disclosed mounting arrangements are well-suited for supporting electronic equipment (e.g., a monitor) in a vehicular application. In particular, a disclosed mounting arrangement supports a monitor forward of an operator of the vehicle and permits the monitor to be positioned within a line of sight of the operator, tilted up and out of the line of sight and translated away from the operator. Two or more tilt positions may be possible when the monitor is in the position in front of or away from the operator. Although the present mounting arrangements are described in the context of a vehicular application, the mounting arrangements may be used in other applications, as well.

A slide assembly with tilt mount includes an outer slide segment defining a first length and an inner slide segment slidably engaged with the outer slide segment. The inner slide segment defines a second length that is less than said first length. A mount is carried by the inner slide segment and includes a mounting bracket configured to support a piece of electronic equipment, such as a monitor. At least one pivot assembly is interposed between the mount and the inner slide segment. The at least one pivot assembly permits the mount to be tilted relative to the inner slide segment. Preferably, the slide assembly permits at least four locked positions of the monitor or other electronic equipment.

### BRIEF DESCRIPTION OF THE DRAWINGS

These and other features, aspects and advantages of the mounting arrangements are described with reference to drawings of preferred embodiments, which are intended to illustrate and not to limit the present mounting arrangements.

FIG. 1 is a perspective view of a slide assembly with tilt mount, which supports electronic equipment, such as a monitor, in a vehicle.

FIG. 2 is a perspective view of the slide assembly with tilt mount separate from the vehicle and with the electronic equipment removed for clarity.

FIG. 3 is a front view of the slide assembly with tilt mount of FIG. 2.

FIG. 4 is a side view of the slide assembly with tilt mount of FIG. 2.

FIG. 5 is an enlarged side view of a portion of the slide assembly with tilt mount of FIG. 4.

FIG. 6 is a rear perspective view of the slide assembly with tilt mount of FIG. 2.

FIG. 7 is a side view of another slide assembly.

FIG. 8 is a perspective view of the slide assembly of FIG. 7 with the inner slide segment hidden to show the rollers.

FIG. 9 is a perspective view of another slide assembly.

FIG. 10 is a side perspective view of the slide assembly with portions removed to show the solid bearing surfaces of the inner and outer slide segments.

### DETAILED DESCRIPTION OF THE PREFERRED EMBODIMENTS

Several embodiments of a mounting arrangement or slide assembly with tilt mount are disclosed herein. The mounting arrangements are disclosed in the context of a vehicular application; however, other applications are also possible. Terms such as “up,” “down,” “above,” “below,” “forward,” “rearward” and other relative terms are used for convenience in describing the particular orientations shown in the figures. The use of such terms is not intended to limit the orientation of the mounting arrangements to those disclosed.

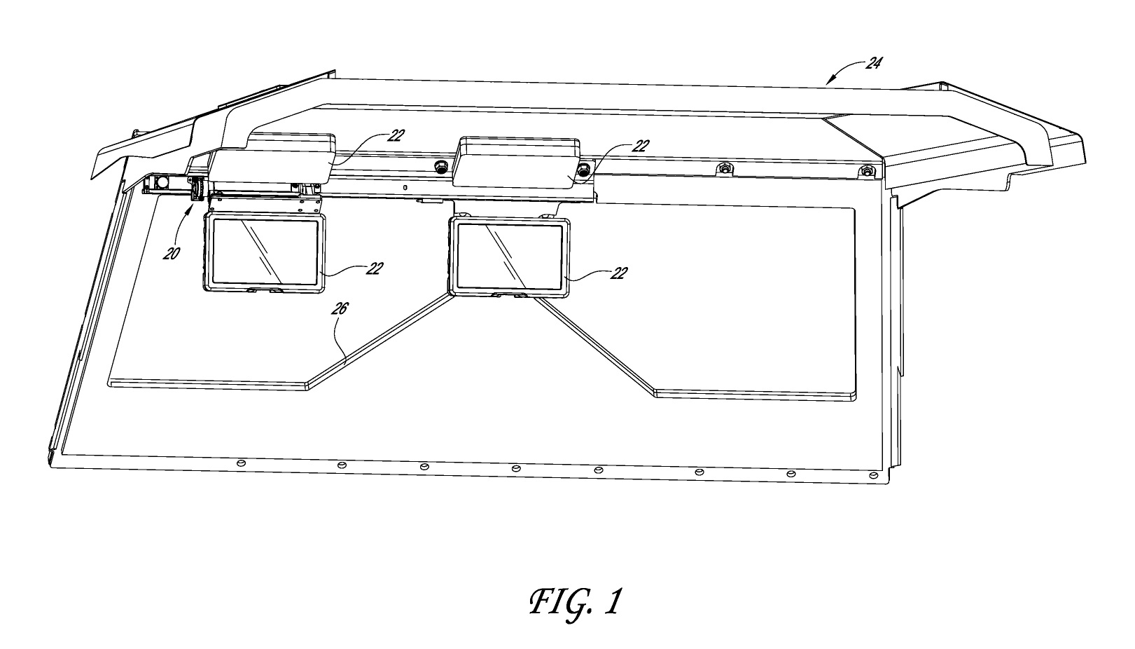

FIG. 1 illustrates a mounting arrangement, slide assembly with tilt mount, or, simply, slide assembly 20 supporting electronic equipment, such as a monitor 22, in a vehicle 24. The illustrated slide assembly 20 supports the monitor 22 in multiple orientations or positions. For example, the slide assembly 20 can support the monitor 22 in at least four positions, with at least one of the positions placing the monitor within the line of sight of an operator of the vehicle 24. The operator is the driver of the vehicle 24 in at least some arrangements, but could be another occupant of the vehicle, as well. The line of sight of the operator includes a view of the driver or other occupant through a windshield 26, windscreen or other window of the vehicle. The line of sight can also refer to the view of an occupant towards an object other than a window, such as another piece of equipment, for example. Preferably, the slide assembly 20 allows the monitor 22 to be positioned in front of the occupant, such as within the occupant's line of sight, tilted up from the occupant's line of sight, translated to a lateral position beside the occupant and tilted up or down in the lateral position. The slide assembly 20 can also permit the monitor 22 to be placed in one or more intermediate positions. As described later, preferably, the slide assembly 20 permits the monitor 22 to be locked or secured in any of the positions.

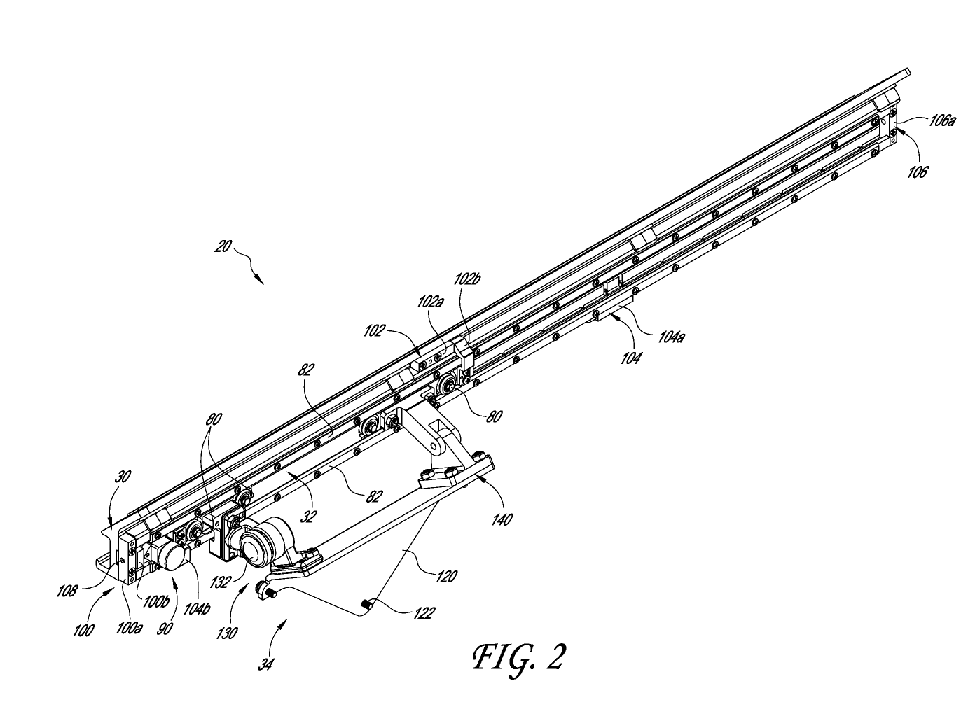

With reference to FIG. 2, the slide assembly 20 includes an elongate member, which can be a rail, channel or a first slide segment 30. The slide assembly 20 also includes a second slide segment 32 that is slidably engaged with the first slide segment 30. In the illustrated arrangement, the first slide segment 30 is an outer slide segment and the second slide segment 32 is an inner slide segment. The outer slide segment 30 at least partially surrounds the inner slide segment 32. The outer slide segment 30 defines a first length that is greater than the length of the inner slide segment 32, which defines a second length. Preferably, the outer slide segment 30 is at least twice as long as the inner slide segment 32 and may be about 2.5 times as long. Thus, inner slide segment 32 can move from one end of the outer slide segment 30 to the other end. The second or inner slide segment 32 carries a mount 34, which is configured to support electronic equipment, such as the monitor 22. Preferably, the mount 34 permits tilt adjustment of the monitor 22.

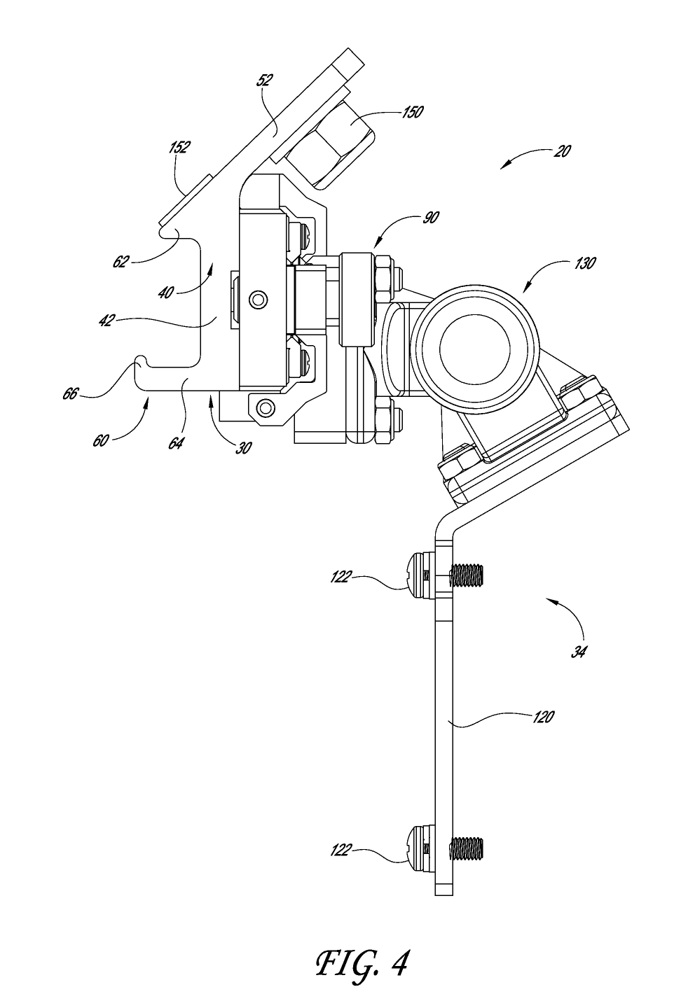

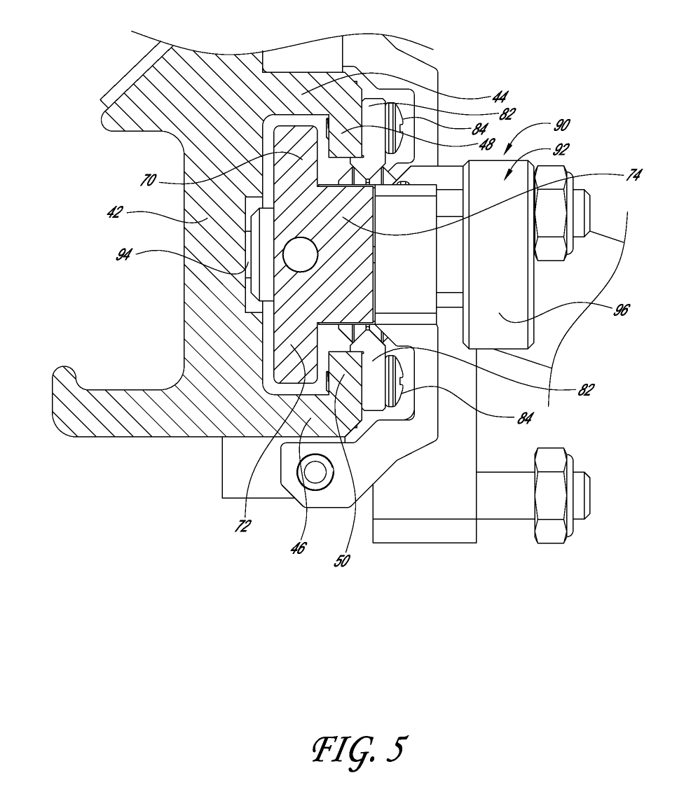

With primary reference to FIGS. 4 and 5, the illustrated outer slide segment 30 includes a generally or substantially C-shaped portion 40 in cross-section, which includes a web portion 42, an upper leg or flange 44, a lower leg or flange 46, and upper return leg 48 and a lower return leg 50. The C-shaped portion 40 defines an interior space configured to receive the inner slide segment 32. The outer slide segment 30 also includes a mounting portion 52, which permits the outer slide segment 30, and slide assembly 20, to be mounted to an object, such as a vehicle 24. Preferably, the mounting portion 52 is generally or substantially planar and extends at an angle from the web portion 42. In the illustrated arrangement, the mounting portion 52 extends in a direction toward the flanges 44, 46 and return legs 48, 50 and toward the inner slide segment 32. The outer slide segment 30 preferably also includes a generally or substantially C-shaped portion 60 that faces the opposite direction from the C-shaped portion 40. The C-shaped portion 60 includes the web 42, an upper leg or flange 62, a lower leg or flange 64 and a lower return leg 66. The C-shaped portion 60 could also include an upper return leg; however, in the illustrated arrangement it does not. The C-shaped portion 60 defines an interior space that can be used as a cable trough to accommodate electronic cables or other objects. In the illustrated arrangement, the lower flange 64 is aligned with the lower flange 46; however, in other arrangements, these could be offset. In addition, the upper flange 62 is generally or substantially aligned with the upper flange 44; however, in other arrangements, these could be offset.

The inner slide segment 32 is generally or substantially T-shaped in cross-section with an upper arm portion 70, a lower arm portion 72 and a forwardly-projecting base portion 74. The upper arm portion 70 is received within a space defined by the upper flange 44, upper return leg 48 and an upper portion of the web 42. Similarly, the lower arm portion 72 is received within a space defined by the lower flange 46, the lower return leg 50 and a lower portion of the web 42. The base 74 projects outwardly through a space between the upper return leg 48 and lower return leg 50 and provides a surface to which other components of the slide assembly 20 can be mounted.

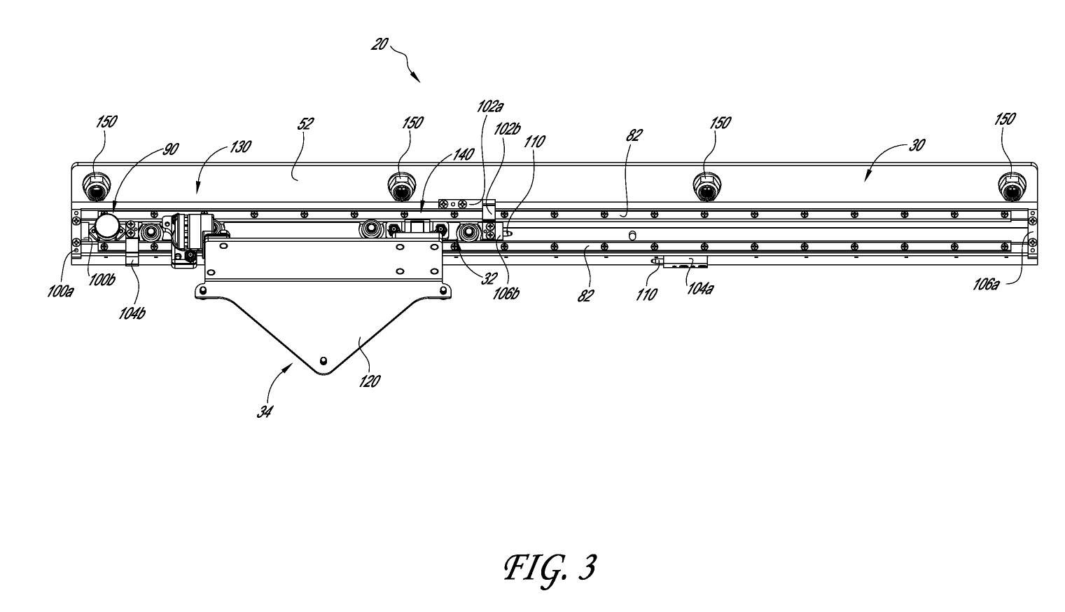

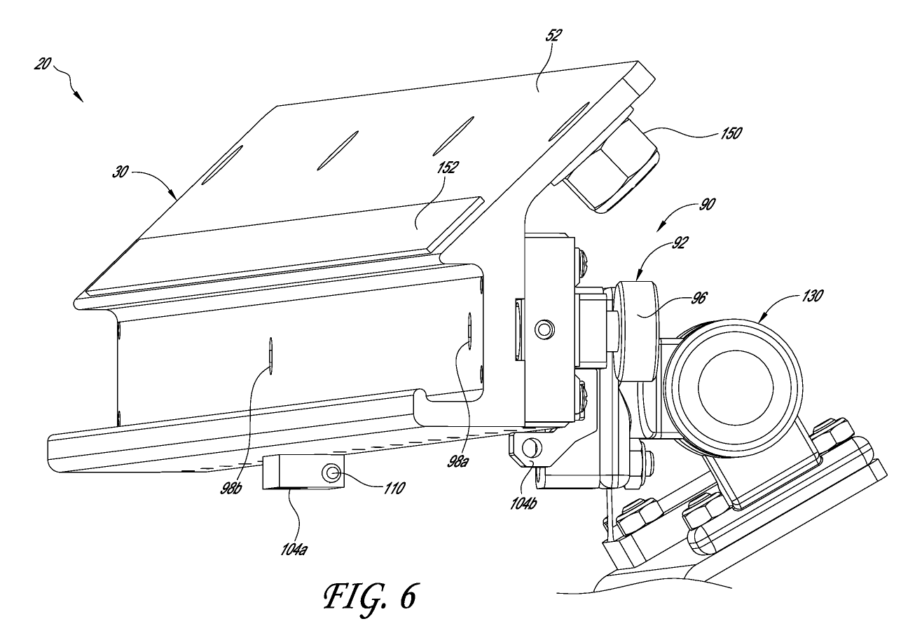

The inner slide segment 32 can be slidably engaged with the outer slide segment 30 by any suitable arrangement, including solid bearing slide surfaces, ball bearing slide surfaces, among others. The illustrated arrangement of FIGS. 1-6 includes several rollers 80 that are carried by one of the slide segments and that roll relative to the other slide segment. In the illustrated arrangement, the rollers 80 are carried by the inner slide segment 32 and roll relative to the outer slide segment 30. Preferably, the rollers 80 define a central groove that engages V-shaped engagement surfaces of the outer slide segment 30. Such an arrangement maintains engagement of the inner slide segment 32 with the outer slide segment 30 while facilitating low-force movement of the inner slide segment 32 along the outer slide segment 30, even when the outer slide segment 30 may be somewhat bent or distorted as a result of an inconsistent mounting surface. For example, in tests of the illustrated slide assembly 20 having a 7.5 pound load on the mount, the pull forces have been measured at about 1-3 pounds, with break-away forces of less than about 5 pounds. In the illustrated arrangement, the V-shaped engagement surfaces are defined by elongate tracks 82 that are separate from and mounted to the outer slide segment 30. Preferably, one of the tracks 82 is mounted to each of the upper return leg 48 and lower return leg 50 of the outer slide segment 30 by any suitable fastening arrangement, such as screws 84. Preferably, each of the rollers 80 engages only one of the upper or lower tracks 82. In the illustrated arrangement, four rollers 80 are provided, with two rollers 80 engaging the upper track 82 and the other two rollers 80 engaging the lower track 82.

The slide assembly 20 can include a position lock mechanism 90 that operates to secure the inner slide assembly 32 in one of two or more available positions. In the illustrated arrangement, the slide assembly 20 has two lockable positions. The position lock mechanism 90 includes a spring-loaded plunger pin 92 having an engagement portion 94 and a handgrip portion 96. The engagement portion 94 is biased toward the outer slide segment 30 and, when the inner slide segment 32 is appropriately positioned, into engagement with one of two engagement holes 98a, 98b of the outer slide segment 30, which define the two lockable positions. However, other lockable positions could also be provided. The handgrip portion 96 permits an operator to grasp the plunger pin 92 and retract the engagement portion 94 from engagement with the engagement holes 98a, 98b so that the inner slide segment 32 can be moved relative to the outer slide segment. The plunger pin 92 can be configured to be secured in the retracted position (such as by rotation of about ¼ turn) so that the inner slide segment 32 can be freely moved. A suitable plunger pin assembly 92 is model no. 27829 sold by Jergens, Inc.

The illustrated slide assembly 20 includes at least one shock block for each available locked position of the inner slide segment 32 (at least two in the illustrated arrangement). The shock blocks provide a precision engagement between the inner slide segment 32 and the outer slide segment 30 to inhibit vibration of the inner slide segment 32 (and, thus, the electronic equipment or monitor 22) relative to the outer slide segment 30. Preferably, the slide assembly 20 includes two shock blocks for each available locked position of the inner slide segment 32, with one shock block being located at or near each end of the inner slide segment 32. For example, in the position of the inner slide segment 32 illustrated in FIGS. 2-6, a first shock block 100 is located at a first end of the inner slide segment 32 and a second shock block 102 is located at a second end of the inner slide segment 32. A third shock block 104 and a fourth shock block 106 are provided at respective first and second ends of the inner slide segment 32 when the inner slide segment 32 is positioned at the opposite end of the outer slide segment 30 from the position illustrated in FIGS. 2-6. Each shock block 100, 102, 104, 106 includes a first portion 100a, 102a, 104a, 106a carried by the outer slide segment 30 and a second portion 100b, 102b, 104b, 106b carried by the inner slide segment 32. A precision opening 108 is defined by one of the first and second portions and a precision pin 110 is defined by the other of the first and second portions. Thus, the opening 108 of a first portion is engaged by the pin 110 of a second portion of each shock block 100, 102, 104, 106 when the inner slide segment 32 is in an appropriate one of the two locked positions. The portions of the shock block can be defined by components separate from one another or other components of the slide assembly 20 or can be integrated with one another or other components of the slide assembly 20. For example, the second portion 106b of the fourth shock block 104 preferably is defined by an end portion of the inner slide segment 32, which carries a pin 110.

The mount 34 can be of any suitable arrangement to support the desired electronic equipment. In the illustrated arrangement, the mount 34 includes a mount plate or bracket 120, which permits one or more fasteners 122 to pass therethrough and into a piece of electronic equipment, such as the monitor 22. The illustrated mount bracket 120 includes a lower portion that is angled relative to an upper portion (e.g., by about 90-160 degrees, or about 135 degrees). The lower portion of the mount bracket 120 supports the monitor 22 and the upper portion provides a location of connection to the inner slide segment 32.

Preferably, a pair of pivot assemblies 130, 140 connects the mounting bracket 120 to the inner slide segment 32. The pivot assembly 130 preferably is a locking hinge or pivot and, preferably, is located on the same side of the mounting bracket 120 as the position lock mechanism 90 (which, preferably, is the position closest to the intended operator). The pivot assembly 130 can be normally-biased into a locked position to secure the pivot assembly 130 in its current position and can be selectively released to permit pivoting movement of the mounting bracket 120. For example, the pivot assembly 130 can include a push button 132 that can be pushed to release the pivot assembly 130 for rotational movement. The pivot assembly 130 can define two positions (e.g., up and down) and, once the push button 132 is pushed, can be moved between the two positions without holding the push button. The pivot assembly 130 then reverts to a locked position once one of the two positions is reached until again released by pushing of the push button 132. Alternatively, the pivot assembly 130 can be lockable in multiple intermediate positions in addition to the endmost positions. One suitable pivot assembly 130 is model no. VSS10360F2PB sold by Adjustable Locking Technologies LLC. The pivot assembly 140 can be a simple free hinge, which relies on the position locking functionality of the pivot assembly 130. The free hinge pivot assembly can be of any suitable construction. In one arrangement, the free hinge pivot assembly is comprised of 2 primary pieces—one that is fixed or otherwise attached to the inner slide segment 32, and does not rotate, and one that is in turn attached to this first piece, which itself does rotate. This rotatable piece is attached to the mounting bracket 120 that has the monitor 22 attached to it. Preferably, both pieces are manufactured from aluminum 6061-T6 material and, in particular, are machined from aluminum bar stock material. The 2 pieces are pinned together thru the axis of rotation with a ¼″ diameter stainless steel dowel pin. The dowel pin has an interference/press-fit thru the rotatable piece and a looser fit thru both ends of the fixed/attached piece. This allows it to freely rotate. However, other suitable materials and constructions can be used.

The slide assembly 20 can be mounted to an object, such as a vehicle 24, by any suitable arrangement. For example, the mounting portion 52 of the outer slide segment 30 can include openings that permit bolts or threaded studs (not shown) of the vehicle 24 to pass therethrough. Nuts 150 can be threadably engaged with the bolts or studs to secure the slide assembly 20 in a proper location within the vehicle 24, which may be above a windshield, windscreen or other window of the vehicle 24 such that the monitor 22 can be folded down into position in front of the windshield 26, windscreen or other window. If desired, compressible members can be interposed between the slide assembly 20 and the vehicle 24 or the nuts 150 and the slide assembly to provide a “soft” mount, which may reduce or minimize distortion of the outer slide segment 30 due to curvature or inconsistency in the mounting surface of the vehicle 24. The slide assembly 20 can also include a compressible material strip 152 extending along the mounting portion 52 such that the strip 152 is positioned between the outer slide segment 30 and the vehicle 24.

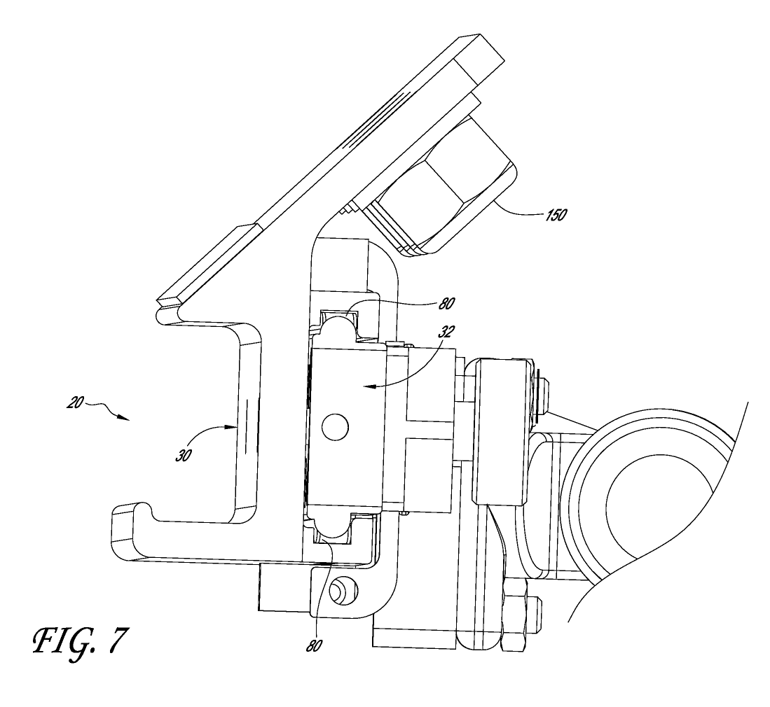

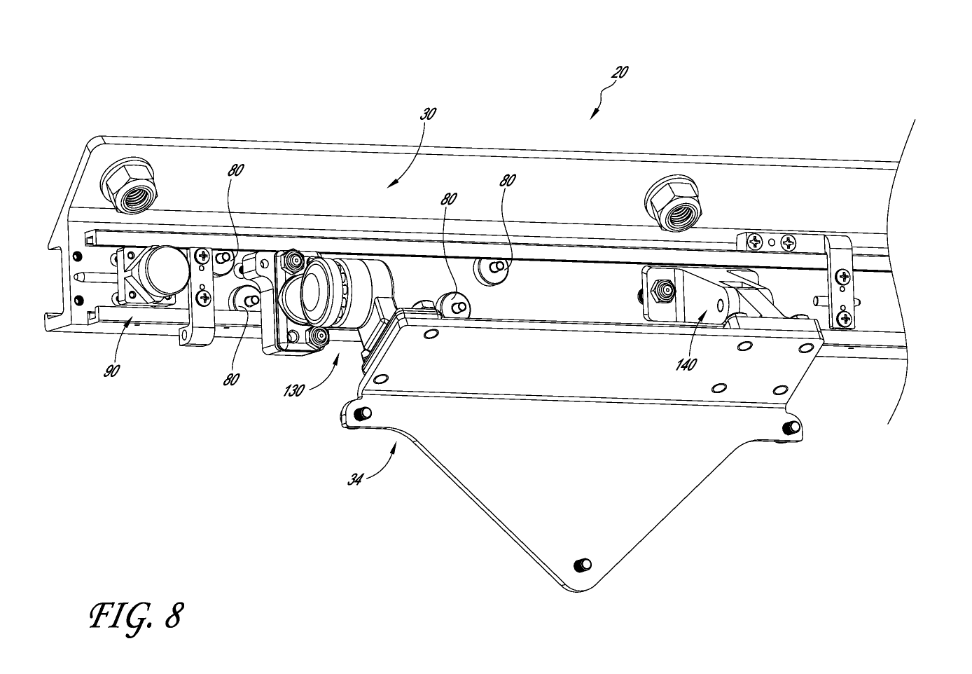

FIGS. 7 and 8 illustrate a slide assembly 20 that is substantially similar to the slide assembly 20 of FIGS. 1-6. However, the slide assembly 20 of FIGS. 7 and 8 include rollers 80 that directly engage inner surfaces of the outer slide segment 30 (as opposed to the tracks 82 of the slide assembly 20 of FIGS. 1-6). Preferably, the outer surface of the rollers 80 are flat and engage corresponding flat surfaces of the outer slide segment 30. However, the rollers 80 could be other shapes as well (e.g., concave or convex).

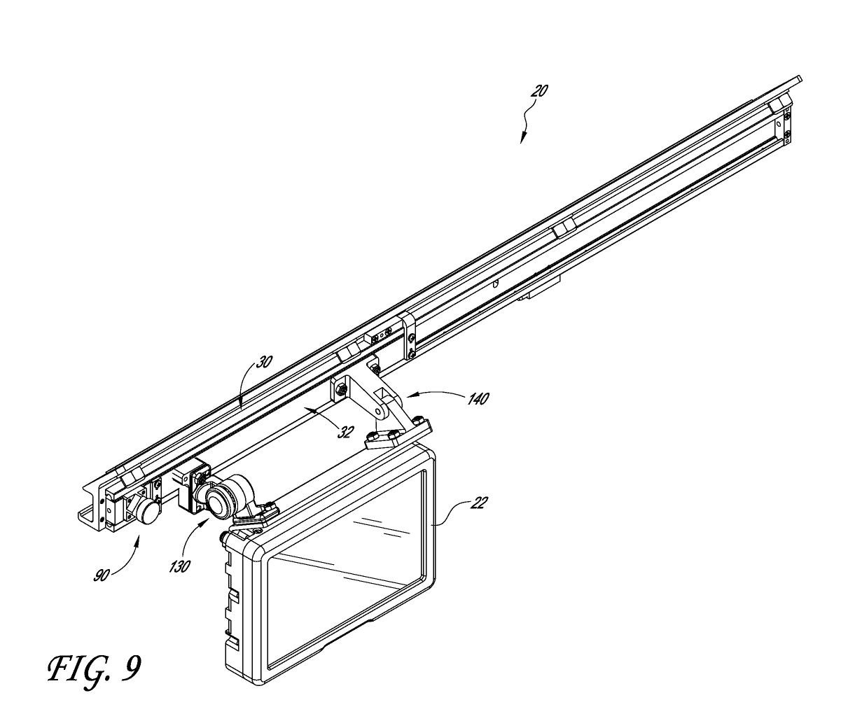

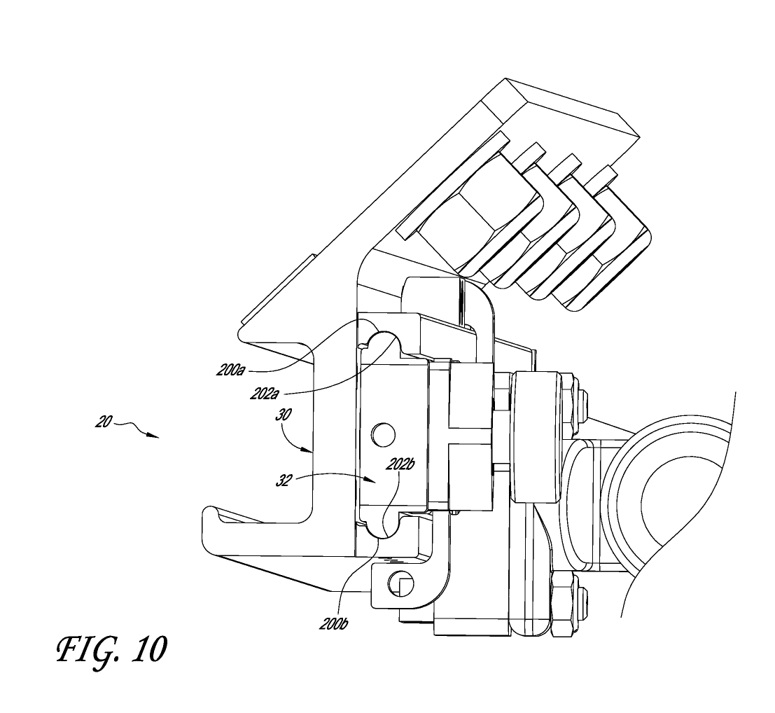

FIGS. 9 and 10 illustrate a slide assembly 20 that is substantially similar to the slide assembly 20 of FIGS. 1-6. However, the slide assembly 20 of FIGS. 9 and 10 is a friction slide or solid bearing slide assembly. That is, preferably, no rollers are provided and the inner slide segment 32 slides relative to the outer slide segment 30 on non-moving or non-rotating surfaces. In the illustrated arrangement, the bearing surfaces 200a, 200b of the outer slide segment 30 are curved (and, preferably, concave) and the bearing surfaces 202a, 202b of the inner slide segment 32 are also curved (and, preferably, convex). Thus, the inner slide segment 32 is permitted to slide along the length of the outer slide segment 30, but relative movement of the segments 30, 32 in other directions is inhibited or prevented.

Although the slide assemblies 20 of FIGS. 7 and 8 and FIGS. 9 and 10 are suitable and capable for the desired purpose of movably supporting electronic equipment, these slide assemblies may require higher forces to initiate and continue movement of the inner slide segment 32 relative to the outer slide segment 30. This is especially the case in applications in which the mounting surface may not be flat or there is significant variation in the mounting surface which may cause undesired deflection or deformation of the outer slide segment 30. In such environments, the slide assembly 20 of FIGS. 1-6 is preferred because it reduces the forces required for initial and continued movement of the inner slide segment 32.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present slide assembly has been described in the context of particularly preferred embodiments, the skilled artisan will appreciate, in view of the present disclosure, that certain advantages, features and aspects of the slide assembly may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A slide assembly with tilt mount, comprising:
an outer slide segment defining a first length;
an inner slide segment slidably engaged with the outer slide segment, the inner slide segment defining a second length that is less than said first length;
a mount carried by the inner slide segment, the mount comprising a mounting bracket configured to support a piece of electronic equipment, such as a monitor;
at least one pivot assembly interposed between the mount and the inner slide segment, wherein the at least one pivot assembly permits the mount to be tilted relative to the inner slide segment.

2. The slide assembly of claim 1, wherein the inner slide segment and the outer slide segment have solid bearing surfaces in contact with one another.

3. The slide assembly of claim 1, wherein the inner slide segment carries a plurality of rollers that roll relative to the outer slide segment.

4. The slide assembly of claim 3, wherein each roller contacts one or the other of an upper engagement surface or a lower engagement surface of the outer slide segment.

5. The slide assembly of claim 3, wherein the outer surfaces of the rollers include grooves shaped to engage and roll relative to V-shaped engagement surfaces of the outer slide segment.

6. The slide assembly of claim 5, wherein the V-shaped engagement surfaces are defined by upper and lower tracks secured to the outer slide segment.

7. The slide assembly of claim 1, wherein the at least one pivot assembly comprises a first pivot assembly and a second pivot assembly.

8. The slide assembly of claim 7, wherein at least the first pivot assembly is a locking pivot assembly that is capable of being secured in one or more rotational positions.

9. The slide assembly of claim 8, wherein the second pivot assembly is a free hinge assembly that is not capable of being secured in any particular rotational position.

10. The slide assembly of claim 1, wherein the inner slide segment is lockable in at least two positions along the length of the outer slide segment.

11. The slide assembly of claim 10, further comprising a push button that is configured to release the inner slide segment from one of the locked positions.

12. The slide assembly of claim 10, further comprising a plurality of shock blocks that engage the inner slide segment in each of the locked positions.

13. The slide assembly of claim 12, wherein a shock block engages each end of the inner slide segment in each locked position.

14. The slide assembly of claim 1, wherein the outer slide segment comprises a cable trough on an opposite side of the inner slide segment.

15. The slide assembly of claim 1, wherein the outer slide segment comprises a mounting portion that is angled with respect to a plane that contains the engagement surfaces of the outer slide segment.

16. The slide assembly of claim 1 installed in a vehicle adjacent a windshield, windscreen or other window.

17. The slide assembly and vehicle of claim 16, wherein the slide assembly is installed above the windshield, windscreen or other window.

18. The slide assembly and vehicle of claim 16, wherein the slide assembly is soft-mounted to the vehicle with a compressible member in between the slide assembly and the vehicle or in between the slide assembly and a fastener used to secure the slide assembly to the vehicle.
